(19) United States
(12) Patent Application Publication
(10) Pub. No.: US 2007/0165267 A1
(43) Pub. Date: Jul. 19, 2007

(54) Automated Print Rendering Verification

(75) Inventor: Mariyan D. Fransazov, Redmond, WA (US)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/466,609

(22) Filed: Aug. 23, 2006

Related U.S. Application Data
(60) Provisional application No. 60/743,137, filed on Jan. 17, 2006.

(51) Int. Cl. G06F 3/12

(52) U.S. Cl. 358/1.15

(57) ABSTRACT

Systems and methods for automated print rendering verification are described. In one aspect, a print path for print rendering verification is provided. The print path is used to automatically verify whether data rendered by a print device is substantially equivalent to a target or idealized rendering of the data. A user is then notified whether the print device was able to render such a target rendering from the data.

### RELATED APPLICATION

This patent application claims priority to U.S. provisional patent application Ser. No. 60/743,137, filed on Jan. 17, 2006, and hereby incorporated by reference.

### BACKGROUND

Print devices typically implement a specialized set of commands to perform print operations. A print driver is typically used to translate generic commands received from a program into a compatible set of such specialized commands for the print device. Existing techniques to develop and test print drivers to ensure that they implement functionality that is compatible with specific printer and printer firmware configurations are typically recursive and manually implemented. These testing techniques often involve a human printing test pages with the print driver for visual comparison to a reference page to determine if the test pages represents intended printer output. If difference(s) between test page(s) and the reference page are identified, a software developer typically modifies the print driver to bring the driver's print results closer to that of the reference page. Since existing techniques for print driver testing are manual and dependent upon subjective visual comparisons of rendered output, these techniques are labor-intensive and prone to human error.

### SUMMARY

Systems and methods for automated print rendering verification are described. In one aspect, a print path for print rendering verification is provided. The print path is used to automatically verify whether data rendered by a print device is substantially equivalent to a target or idealized rendering of the data. A user is then notified whether the print device was able to render such a target rendering from the data.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary system for automated print rendering verification, according to one embodiment.

FIG. 2 shows an exemplary procedure for automated print rendering verification, according to one embodiment.

FIG. 3 shows another exemplary procedure for automated print rendering verification, according to one embodiment.

### DETAILED DESCRIPTION

### Overview

Systems and methods for automated print rendering verification are described. Specifically, a print driver converts data from a print job to Page Description Language (PDL). The PDL is sent to a print device for rendering. The print device renders the PDL. The rendering is then programmatically compared (independent of any printing operations) to pre-created reference data. The pre-created reference data represents an idealized representation of data that the print device will generate or closely generate if the PDL was correctly generated by the print driver. Results of the comparison are provided to a user for evaluation. A result indicating that the rendered data was improperly rendered (i.e., different than the reference data by some configurable amount) indicates to the user that the print driver is not compliant within a configurable tolerance level with the print device. In this manner, the systems and methods test a print driver independent of subjective human visual comparisons of printed renderings.

These and other aspects of systems and methods for automated print rendering verification are now described in greater detail.

### An Exemplary System

Although not required, systems and methods for automated print rendering verification are described in the general context of computer-executable instructions executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

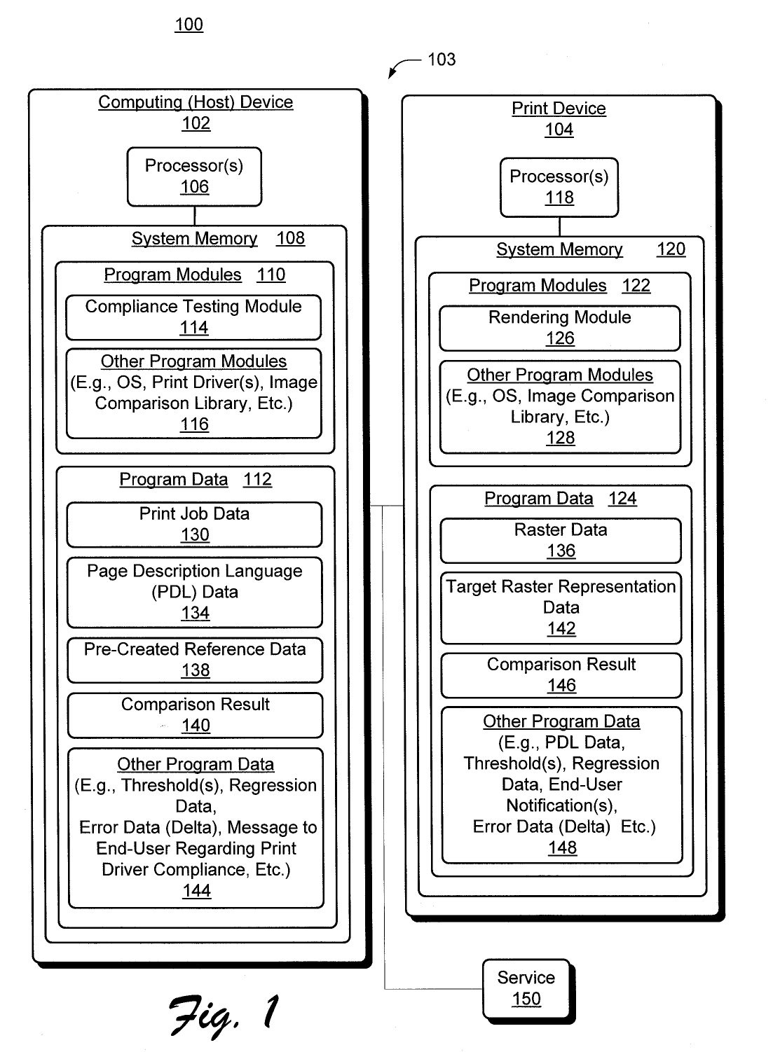

FIG. 1 shows an exemplary system 100 for automated print rendering verification, according to one embodiment. In this example, system 100 includes computing device 102 operatively coupled to print device 104. In one implementation, computing device 102 is operatively coupled to print device 104 via network 103, directly coupled (e.g., via cabling, etc.), or otherwise connected. Computing device 102 and print device 104 each include respective processors coupled to system memory. Such processors include, for example, microprocessors, microcomputers, microcontrollers, digital signal processors, central processing units, state machines, logic circuitries, and/or any devices that manipulate signals based on operational instructions. The processors are configured to fetch and executing computer-program instructions stored in the system memory. Such system memory includes, for example, some combination of volatile memory (e.g., RAM) and non-volatile memory (e.g., ROM, Flash etc.).

For example, computing device 102 includes processor 106 coupled to system memory 108. System memory 108 includes program modules 110 and program data 112. Processor 106 fetches and executes computer-program instructions from respective ones of the program modules 110. Program modules 110 include, for example, compliance testing module 114 and other programs 116 such as an operating system, print driver(s) for compliance testing, etc. In another example, print device 104 includes processor 118 coupled to system memory 120. System memory 120 includes program modules 122 and program data 124. Processor 118 is configured to fetch and execute computer-program instructions from respective ones of program modules 122. In this implementation, for example, program modules 122 includes rendering module 126, and other program modules 128 such as an operating system, and image comparison library, and/or so on.

Various implementations of computing device 102 and print device 104 for automated print rendering verification are now described.

### Exemplary Print Rendering Compliance Determination a by Host Device

Referring to computing device 102, compliance testing module 114 implements a printing architecture with a print path for automated print rendering verification. For example, in one implementation, an entity such as a print driver developer or tester utilizes operations of compliance testing module 114 to communicate print job data 130 to a print driver. For purposes of exemplary illustration, such a print driver is shown as a respective portion of “other program modules” 116. In one implementation, print job data 130 is in an XML Paper Specification (XPS) spool file data format. Print driver converts print job data 130 into Page Description Language (PDL) data 134. Compliance testing module 114 communicates PDL 134 to print device 104. Responsive to receiving PDL 134, rendering module 126 of print device 104 renders PDL 134 into raster data 136. Raster data 136 represents what device 104 would typically print responsive to receiving PDL 134 from print driver.

At this point, existing systems would typically print raster data 136 for manual comparison of a printout by a human to a reference image to determine if the printout represents intended printer output. In contrast to such existing systems, system 100 allows a user to determine whether the raster data 136 is compliant with the reference image independent of any such printout. In one implementation, system 100 does not print out raster data 136. Instead, and in one implementation, rendering module 126, or some other computer-program module of print device 104, communicates raster data 136 back to compliance testing module 114 for automated print rendering verification. In this implementation, responsive to receiving raster data 136, compliance testing module 114 compares raster data 136 to a pre-created reference data 138. Pre-created reference data 138 represents, on a pixel-by-pixel basis, exactly how a properly rasterized version of print job data 130 should appear when rendered by print device 104. In this implementation, compliance testing module 114 compares raster data 136 to pre-created reference data 138 utilizing known fuzzy image comparison techniques to arrive at comparison result 140, although other image comparison techniques could be used as well.

If comparison result 140 indicates that a difference between received raster data 136 and pre-created reference data 138 is less than or equal (or some other evaluation based on implementation) to a configurable threshold amount, compliance testing module 114 indicates that the print driver has passed compliance testing. The configurable threshold represents a maximum allowable difference (e.g., a difference tolerance threshold) between the raster data 136 and the pre-created reference data 138. Otherwise, if comparison result 140 does not comply with such difference tolerance criteria, compliance testing module 114 indicates that print driver has failed compliance testing. Such passing and failing compliance indications can be made in many different manners, for example, by displaying a message to the developer and/or tester of print driver, printing a pass/fail message (independent of printing the rendering), etc. If print driver fails compliance testing, a user can modify and again test the print driver using the automated print rendering verification operations of compliance testing module 114.

In one implementation, compliance testing module 114 stores print driver regression testing data, threshold value(s) utilized to determine print driver compliance, error data, and/or so on, in respective portions of “other program data” 144. This stored data can be used for print driver testing and development analysis. Such other program data can be stored in the computing device 102 and/or the print device 104.

### Exemplary Print Rendering Compliance Determination by Print Device

In yet another implementation, print device 104 performs the comparison of raster data 136 to pre-created reference data 138. In this implementation, print device 104 (and more particularly rendering module 126) receives and renders PDL 134 to generate raster data 136. In this implementation, rendering module 126 also receives pre-created reference data 138 from compliance testing module 114. Again, pre-created reference data 138 represents, on a pixel-by-pixel basis, a properly rasterized version (i.e., an ideal target rendering) of print job 130. For purposes of exemplary differentiation, this communicated pre-created reference data 138 is shown on print device 104 as target raster representation 142.

After generating raster data 136 from PDL 134, rendering module 126 (or some other computer-program module on print device 104 such as a compliance testing module portion of “other program data” 148) compares raster data 136 to target raster representation 142 to generate comparison result 146. In one implementation, such comparison operations are performed with known fuzzy image comparison techniques, although other raster image comparison techniques could also be used. If comparison result 146 indicates that the difference between received raster data 136 and target raster representation 142 is less than (or equal to) a configurable threshold amount, print device 104 indicates that print driver that generated PDL 134 has passed compliance testing. Otherwise, print device 104 indicates that print driver has failed compliance testing. Such passing and failing compliance indications can be made in many different manners. For example, in one implementation, print device 104 communicates a compliance message to compliance testing module 1114 of computing device 102 for presentation by computing device 102 to a user. In another implementation, device 104 displays or prints an indication of whether print driver passed or failed compliance testing.

### Exemplary Procedures

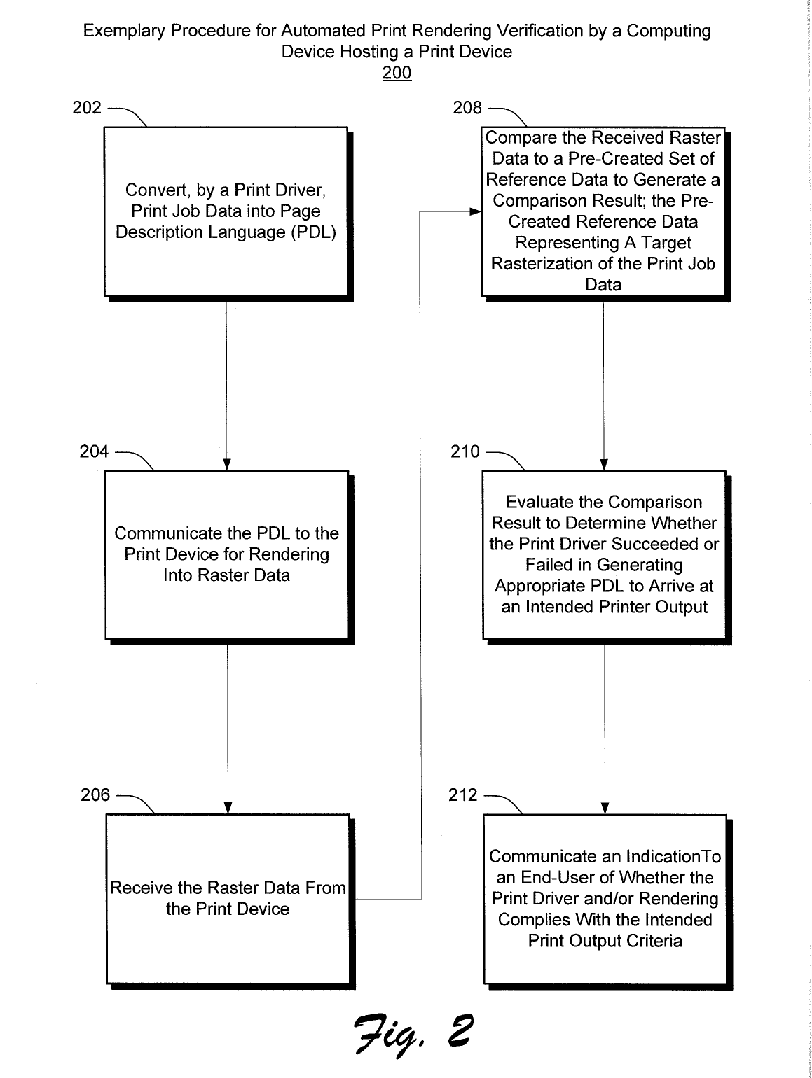

FIG. 2 shows an exemplary procedure 200 for a computing device hosting a printer to automate a paperless print rendering verification system, according to one embodiment. For purposes of exemplary illustration and description, the operations of procedure 200 are described with respect to components of FIG. 1. In the description, the leftmost numeral of a reference number indicates the first figure in which a component (or operation) is introduced. For example, the left-most reference numeral of compliance testing module 114 is a “1”. Thus, compliance testing module 114 is first introduced in FIG. 1.

Referring to FIG. 2, operations of block 202 convert, by a print driver, print job data 130 into a PDL 134. Ideally, PDL 134 is in a format supported by the print device 104, although it is possible that PDL 134 may not be supported by the print device (in the latter scenario, the print driver would be found to be non-conformant using the following described operations). In one implementation, the print job 130 is in an XPS spool data format. In one implementation, the operations of block 202 are implemented by compliance testing module 114 (FIG. 1) communicating print job data 130 to print driver to generate PDL 134. In another implementation, PDL 134 has already been generated by the print driver, which may (or may not) reside on the same computing device 102 as compliance testing module 114.

Operations of block 204 communicate PDL 134 to the print device 104 for rendering into raster data 136. In one implementation, for example, compliance testing module 114 communicates PDL 134 to print device 104 for rendering into raster data 136. In one implementation, for example, rendering module 126 of print device 104 renders PDL 134 into raster data 136. Operations of block 206 receive the raster data 136 from the print device 104. For example, in one implementation, compliance testing module 114 receives raster data 136 from rendering module 126. At block 208, the exemplary operations compare the received raster data 136 to a pre-created set of reference data 138 to generate a comparison result. The pre-created reference data 138 represents a target rasterization of the converted print job 130 (i.e., the PDL 134). For example, in one implementation, compliance testing module 114 compares received raster data 136 to pre-created reference data 138 to generate comparison result 140.

At block 210, the comparison result is evaluated to determine whether the print driver successfully generated appropriate PDL to arrive at an intended output for the print job 130. For example, in one implementation, compliance testing module 114 evaluates comparison result 140 against a predefined and configurable threshold for enforcing an intended print output quality criteria (i.e., represented by pre-created reference data 138). At block 212, a print driver compliance indication is communicated to an end-user. The indication indicating whether the print driver successfully generated PDL 134 (from a print job) is such a manner as to enable print device 104 to render the PDL 134, and there from, generate raster data 136 that substantially matches pre-created reference data 138. In one implementation, for example, compliance testing module 114 presents a message to a print driver developer, tester, or other entity indicating whether print driver succeeded in generating PDL 134 that enabled print device 104 to create raster data 136 that was substantially similar (e.g., by some threshold amount) to pre-created reference data 138.

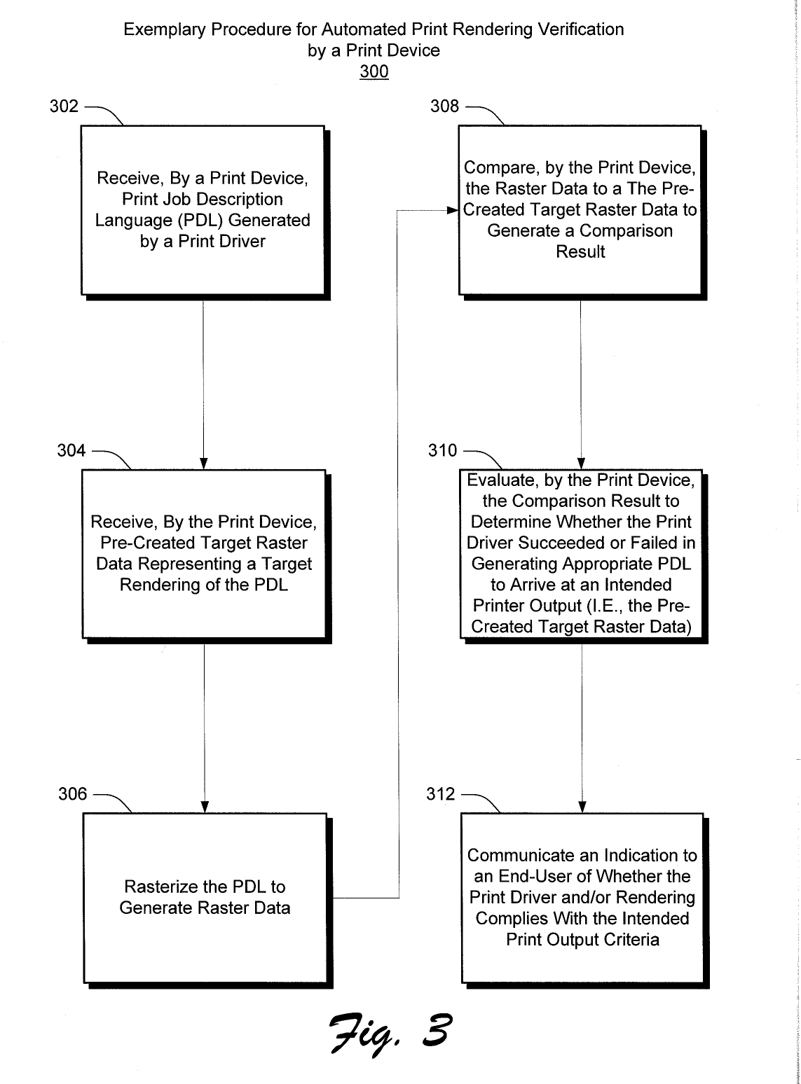

FIG. 3 shows an exemplary procedure 300 for a print device 104 to automate print rendering verification, according to one embodiment. For purposes of exemplary illustration and description, the operations of the procedure are described with respect to components of FIGS. 1 and 2. In the description, the leftmost numeral of a reference number indicates the first figure in which a component or operation is introduced.

Operations of block 302 receive PDL 134 (FIG. 1) generated by a print driver. For example, in one implementation, print device 104 receives PDL 134 from computing device 102. Operations of block 304 correspond to a print device receiving pre-created target raster data representing an ideal rendering of the PDL generated by the print driver. For example, in one implementation, print device 104 receives pre-created target raster data 136 representing an exemplary ideal rendering of PDL 134, generated by the print driver. Operations of block 306 render the PDL to generate raster data. For example, print device 104, and more particularly in this implementation, rendering module 126 rasterizes (or renders) received PDL 134 to generate raster data 136.

Operations of block 308 compare rasterized data to the pre-created reference data (i.e., target raster representation data) to generate a comparison result. As indicated above, pre-created target raster data represents an exemplary target rendering of print driver generated PDL from a print job. In one implementation, for example, rendering module 126, or “other program module 128 (e.g., an application or image comparison library function accessed by an application), compares raster data 136 to target raster representation data 142 to generate comparison result 146. Operations of block 310 evaluate such a comparison result to determine whether the print driver successfully generated PDL appropriate to arrive at a target output for the print job. For example, in one implementation, rendering module 126 evaluates comparison result 140 against a predefined and configurable threshold to determine whether visual distance between raster data 136 and target raster representation data 142 is acceptable. In other words, if raster data 136 were to be printed by print device 104, would the printed output represent intended print output? That is, did print driver maintain the original fidelity of print job 130 when generating PDL 134?

At block 312, procedure 300 communicates an indication to an end-user (such as a developer and/or tester of the print driver used to generate the PDL that was rasterized by the printer) to notify the end-user whether the print driver failed or succeeded in preserving intended output of the printer. For example, in one implementation, rendering module 126 (or a respective “other program module” 128) notifies the end-user whether print driver succeeded or failed in preserving intended output for printer 104. Such notification can be done in numerous different manners. For example, in one implementation, print device 104 communicates a message to computing device 102 for presentation to the end-user. In another implementation, print device 104 displays (e.g., via an LCI), etc) or prints the message to the end-user.

### CONCLUSION

Although the systems and methods for automated print rendering verification have been described in language specific to structural features and/or methodological operations or actions, it is understood that the implementations defined in the appended claims are not necessarily limited to the specific features or actions described. For example, system 100 of FIG. 1 is described above with respect to a computer 102 or a print device 104 verifying a print rendering (e.g., or print driver compliance). However, in a different implementation, a computing device (e.g., service 150 of FIG. 1) other than devices 102 and 104 provides such print rendering verification. In this different implementation, an independent computing device coupled to computing device 102 and print device 104 over network 103 provides the print verification operations as a service to a user of the computing device 102. Accordingly, the specific features and operations of system 100 are disclosed as exemplary forms of implementing the claimed subject matter.

1. A method at least partially implemented by a computer, the method comprising:
verifying via a print path whether data rendered by a print device represents a target rendering of a print job; and
responsive to the verifying, notifying a user whether the data adequately represents the target rendering.

2. The method of claim 1, wherein the print job is in an XML Paper Specification (XPS) spool file data format.

3. The method of claim 1, wherein the verifying is performed by the computer.

4. The method of claim 1, wherein the verifying is performed by the printer.

5. The method of claim 1, wherein at least the verifying is performed by a networked computing device providing print driver compliance services to a different computing device that is testing print driver compliance to the print device.

6. The method of claim 1, wherein the verifying further comprises comparing, the data to pre-created reference data, the pre-created reference data representing the target rendering.

7. The method of claim 1, wherein the verifying further comprises evaluating the data in view of pre-created reference data representing the target rendering to determine whether a difference between the data in view of the pre-created reference data is less than or equal to a configurable threshold value.

8. The method of claim 1, wherein the verifying further comprises using fuzzy logic to compare the data to pre-created reference data representing the target rendering.

9. The method of claim 1, wherein verifying further comprises:
receiving, by the print device, page description language (PDL) from the computer, the PDL having been generated by a print driver from the print job;
generating, by the print device, the data from the PDL; and
comparing, by the print device, the data to the target rendering, or communicating, by the print device, the data to the computer for comparison by the computer of the data to the target rendering.

10. The method of claim 1, wherein the notifying further comprises indicating to the user whether a print driver generated page description language was adequate for the print device to generate the target rendering.

11. The method of claim 1, wherein the method further comprises:
communicating page description language (PDL) to the print device, the PDL having been generated by a print driver from the print job; and
receiving the data from the print device, the data being generated from the PDL by the print device.

12. The method of claim 1, further comprising converting, by the print driver, information associated with the print job into page description language for rendering by the print device to generate the data.

13. A computer-readable medium including computer-program instructions executable by a processor at a print device, the computer-program instructions when executed by the processor for performing operations comprising:
receiving page description language (PDL) data from a computing device, the PDL having been generated by a print driver from a print job;
rendering the PDL to generate rendered data;
communicating the rendered data to the computing device; and
wherein the communicating causes the computing device to evaluate and notify a user whether the PDL generated by the print driver is in compliance with a pre-created target rendering of the print job.

14. The computer-readable medium of claim 13, wherein the print job is in an XML Paper Specification (XPS) spool file data format.

15. The computer-readable medium of claim 13, further comprising displaying a message to the user, the message indicating whether the PDL generated by the print driver is in compliance with the pre-created target rendering.

16. The computer-readable medium of claim 13, further comprising printing a message indicating whether the PDL generated by the print driver is in compliance with the pre-created target rendering.

17. A printer comprising:
a processor; and
a memory coupled to the processor, the memory comprising computer-program instructions executable by the processor for performing operations comprising:
receiving page description language (PDL) data and a pre-created target rendering of a print job from a computing device, the PDL having been generated by a print driver from the print job, the pre-created target reference data representing a target rendering of the print job;
rasterizing the PDL to generate raster data;
comparing the raster data to the pre-created reference data; and
responsive to the comparing, notifying a user of the computing device whether the print driver properly generated the PDL to arrive at a compliance level of the target rendering.

18. The printer of claim 17, wherein the print job is in an XML Paper Specification (XPS) spool file data format.

19. The printer of claim 17, wherein comparing further comprises comparing the raster data and the pre-created reference data in view of a difference tolerance threshold.

20. The printer of claim 17, wherein comparing further comprises comparing the raster data and the pre-created reference data using fuzzy logic techniques.
